(19) United States
(12) Patent Application Publication
(10) Pub. No.: US 2026/0343634 A1
(43) Pub. Date: Oct. 29, 2026

(54) ACCESS POINT AUTHORIZATION FOR PREEMPTION IN WIRELESS TRANSMISSION

(71) Applicant: Cisco Technology, Inc., San Jose, CA (US)

(72) Inventors: Binita Gupta, San Diego, CA (US); Brian Donald Hart, Sunnyvale, CA (US); Malcolm Muir Smith, Richardson, TX (US)

(21) Appl. No.: 19/547,491

(22) Filed: Feb. 23, 2026

Related U.S. Application Data
(63) Continuation of application No. 19/269,917, filed on Jul. 15, 2025.
(60) Provisional application No. 63/671,731, filed on Jul. 15, 2024.
(60) Provisional application No. 63/671,725, filed on Jul. 15, 2024.

(51) Int. Cl. H04W 76/10; H04W 28/02; H04W 88/08

(52) U.S. Cl. CPC H04W 76/10; H04W 28/0268; H04W 88/08

(57) ABSTRACT

Aspects of the present disclosure are directed to providing preemption authorizations to support transmission of low latency network traffic. In one example, a method includes receiving, at an access point, a message indicating parameters associated with network traffic to be exchanged between the access point and an end device; determining, by the access point, at least one type of preemption authorization for the network traffic based on the parameters, the at least one type of preemption authorization being one or more of a flow-based preemption authorization, traffic type-based preemption authorization, and an end device-based preemption authorization; and signaling, by the access point, the at least one type of preemption authorization to the end device.

### CROSS-REFERENCE TO RELATED APPLICATIONS

This application is a continuation of U.S. Patent Application No. 19/269,917, filed on Jul. 15, 2025, entitled, “ACCESS POINT AUTHORIZATION FOR PREEMPTION IN WIRELESS TRANSMISSION”, which in turn claims priority to and benefit of U.S. Provisional Application Number 63/671,725 filed on Jul.15, 2024 entitled, “ENABLING PREEMPTION IN A BSS”, and U.S. Provisional Application Number 63/671,731 filed on Jul. 15, 2024 entitled, “ACCESS POINT AUTHORIZATION FOR PREEMPTION”, the entireties of which are incorporated herein by reference.

### TECHNICAL FIELD

The present disclosure relates to wireless communication standards and providing preemption authorizations for low latency network traffic, and in particular, to mechanisms for providing different types of preemption authorizations including flow-based, traffic type-based, and device-based preemption authorizations.

### BACKGROUND

Wi-Fi technology has undergone continuous evolution and innovation since its inception, resulting in significant advancements with each new generation. Following Wi-Fi 5 (802.11ac) there has been Wi-Fi 6 (802.11ax), Wi-Fi 7 (802.11be), and soon there will be Wi-Fi 8 (802.11bn) and Wi-Fi 9, each new Wi-Fi generation brings notable improvements in speed, capacity, efficiency, and overall performance.

Wi-Fi 5 introduced substantial upgrades over its predecessor, Wi-Fi 4 (802.11n). It introduced the use of wider channel bandwidths, multi-user Multiple-Input Multiple-Output (MIMO), and beamforming technologies. These advancements significantly increased data transfer rates and improved network capacity, allowing multiple devices to simultaneously connect and communicate more efficiently. Wi-Fi 6/6E included enhanced orthogonal frequency-division multiple access (OFDMA) and target wake time (TWT) mechanisms and included greater frequency and improved overall spectral efficiency and power management and better performance in crowded areas. Wi-Fi 7 (802.11be) delivers speeds of up to 30 Gbps, utilizing multi-band operation, wider bandwidth, advanced MIMO techniques, and improved modulation schemes. Wi-Fi 7 also focuses on reducing latency and enhancing security features.

Wi-Fi 8 (802.11bn) aims to revolutionize wireless connectivity by providing ultra-high reliability enabling rich experiences for QoS demanding applications such as cloud gaming, AR/VR, industrial IoT, wireless TSN etc. Wi-Fi 8 is expected to introduce advancements like seamless roaming, multi-AP coordination for predictable QoS, enhanced power saving and advanced beamforming techniques paving the way for futuristic applications and seamless connectivity experiences.

As Wi-Fi technology continues to evolve, each new Wi-Fi generation brings improvements that address the growing demands of modern networks, including increased device density, higher data rates, lower latency, improved reliability and better overall network performance. These advancements play a crucial role in enabling emerging technologies, supporting the proliferation of smart devices, and transforming the way we connect and communicate in an increasingly interconnected world.

### BRIEF DESCRIPTION OF SEVERAL VIEWS OF THE DRAWINGS

To easily identify the discussion of any particular element or act, the most significant digit or digits in a reference number refer to the figure number in which that element is first introduced.

FIG. 1 illustrates a block diagram of an example wireless communication network according to some aspects of the present disclosure.

FIG. 2A illustrates an example of a single floor of building equipped with wireless communication according to some aspects of the present disclosure.

FIG. 2B depicts an illustrative schematic diagram for MLO between an AP MLD with affiliated logical entities and a non-AP MLD with affiliated logical entities according to some aspects of the present disclosure.

FIG. 3 illustrates an example architecture 300 in which multi-AP coordination technologies may be practiced according to some aspect of the present disclosure.

FIG. 4 illustrates an example method of granular preemption authorization use, according to some aspects of the present disclosure.

FIG. 5 is a visualization of a preemption authorization and enablement lifecycle, according to some aspects of the present disclosure.

FIG. 6 shows an example of computing system according to some aspects of the present disclosure.

### DETAILED DESCRIPTION

Various embodiments of the disclosure are discussed in detail below using examples. While specific implementations are discussed, it should be understood that this is done for illustration purposes only. A person skilled in the relevant art will recognize that other components and configurations may be used without parting from the spirit and scope of the disclosure. Thus, the following description and drawings are illustrative and are not to be construed as limiting. Numerous specific details are described to provide a thorough understanding of the disclosure. However, in certain instances, well-known or conventional details are not described in order to avoid obscuring the description. References to one or an embodiment in the present disclosure can be references to the same embodiment or any embodiment; and such references mean at least one of the embodiments.

Reference to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others.

A used herein the term “configured” shall be considered to interchangeably be used to refer to configured and configurable unless the term “configurable” is explicitly used to distinguish from “configured.” The proper understanding of the term will be apparent to persons of ordinary skill in the art in the context in which the term is used.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, or A and B and C. The language “at least one of” a set and/or “one or more” of a set does not limit the set to the items listed in the set. For example, claim language reciting “at least one of A and B” or “at least one of A or B” can mean A, B, or A and B, and can additionally include items not listed in the set of A and B.

The terms used in this specification generally have their ordinary meanings in the art, within the context of the disclosure, and in the specific context where each term is used. Alternative language and synonyms may be used for any one or more of the terms discussed herein, and no special significance should be placed upon whether or not a term is elaborated or discussed herein. In some cases, synonyms for certain terms are provided. A recital of one or more synonyms does not exclude the use of other synonyms. The use of examples anywhere in this specification including examples of any terms discussed herein is illustrative only and is not intended to further limit the scope and meaning of the disclosure or of any example term. Likewise, the disclosure is not limited to various embodiments given in this specification.

Without intent to limit the scope of the disclosure, examples of instruments, apparatus, methods, and their related results according to the embodiments of the present disclosure are given below. Note that titles or subtitles may be used in the examples for convenience of a reader, which in no way should limit the scope of the disclosure. Unless otherwise defined, technical and scientific terms used herein have the meaning as commonly understood by one of ordinary skill in the art to which this disclosure pertains. In the case of conflict, the present document, including definitions, will control.

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims or can be learned by the practice of the principles set forth herein.

Aspects of the present disclosure can be implemented in any device, system or network that is capable of transmitting and receiving radio frequency (RF) signals according to one or more of the Institute of Electrical and Electronics Engineers (IEEE) 802.11 standards, the IEEE 802.15 standards, the Bluetooth® standards as defined by the Bluetooth Special Interest Group (SIG), or the Long Term Evolution (LTE), 3G, 4G or 5G (New Radio (NR)) standards promulgated by the 3rd Generation Partnership Project (3GPP), among others. The described implementations can be implemented in any device, system or network that is capable of transmitting and receiving RF signals according to one or more of the following technologies or techniques: code division multiple access (CDMA), time division multiple access (TDMA), frequency division multiple access (FDMA), orthogonal FDMA (OFDMA), single-carrier FDMA (SC-FDMA), single-user (SU) multiple-input multiple-output (MIMO) and multi-user (MU) MIMO. The described implementations also can be implemented using other wireless communication protocols or RF signals suitable for use in one or more of a wireless personal area network (WPAN), a wireless local area network (WLAN), a wireless wide area network (WWAN), or an internet of things (IOT) network.

### OVERVIEW

Aspects of the present disclosure are directed to providing preemption authorizations to support transmission of low latency network traffic. As will be described, different types of preemption authorization may be granted by an access points such as flow-based preemption authorization (e.g., specific flows), traffic-type based (e.g., based on Traffic Identifier (TID) and/or Access Category (AC)), and/or device-specific (e.g., specific end device and/or groups of end devices).

In one example, a method includes receiving, at an access point, a message indicating parameters associated with network traffic to be exchanged between the access point and an end device; determining, by the access point, at least one type of preemption authorization for the network traffic based on the parameters, the at least one type of preemption authorization being one or more of a flow-based preemption authorization, traffic type-based preemption authorization, and an end device-based preemption authorization; and signaling, by the access point, the at least one type of preemption authorization to the end device.

In another aspect, the method further includes determining the at least one type of preemption authorization based on the parameters and a preemption policy of the access point.

In another aspect, the parameters include one or more of Quality of Service (QoS) requirement or preemption requirements associated with the network traffic, and the network traffic is a periodic or event-based Low Latency (LL) network traffic.

In another aspect, the parameters are included in a QoS characteristics element of a Stream Classification Service (SCS) request frame.

In another aspect, the at least one type of preemption authorization is the flow-based preemption authorization that allows preemption for at least one specific traffic flow.

In another aspect, the flow-based preemption authorization is signaled to the end device in a Stream Classification Service Response (SCS Response).

In another aspect, the SCS Response is sent in response to an SCS request frame via which the parameters are received or via an unsolicited SCS Response.

In another aspect, the flow-based preemption authorization is signaled in an SCS Descriptor element or another subelement of the SCS Response.

In another aspect, the flow-based preemption authorization specifies a frequency of the flow-based preemption authorization and one or more time periods during which the flow-based preemption authorization is valid.

In another aspect, the parameters are included in a Preemption element of a (Re)Association Request.

In another aspect, the at least one type of preemption authorization is the traffic type-based preemption authorization that allows preemption for one or more of at least one Traffic Identifiers (at least one TID) or at least one Access Category (at least one AC).

In another aspect, the parameters identify the at least one TID or the at least one AC for which the end device is requesting preemption authorization.

In another aspect, the traffic type-based preemption authorization is signaled to the end device in a Preemption Element of a (Re)Association Response.

In another aspect, the traffic type-based preemption authorization specifies a frequency of the traffic type-based preemption authorization and one or more time periods during which the traffic type-based preemption authorization is valid.

In another aspect, the at least one type of preemption authorization is the end device-based preemption authorization that allows preemption for one or more specific end devices.

In another aspect, the end device-based preemption authorization is signaled to the end device in a Preemption Element of a (Re)Association Response.

In another aspect, the end device-based preemption authorization specifies a frequency of the end device-based preemption authorization and one or more time periods during which the end device-based preemption authorization is valid.

In another aspect, the message includes a preemption request, the preemption request being one or more of a flow specific, a traffic type specific, and end device specific preemption request, and the end device determines the at least one type of preemption authorization based on the preemption request, the preemption policy, and additional Stream Classification Service (SCS) flows known to the access point.

In another aspect, the message is a Preemption Request received from the end device, and the at least one type of preemption authorization is signaled to the end device in a Preemption Response.

In another aspect, the method further includes detecting a triggering condition for terminating the at least one type of preemption authorization; and terminating the at least one type of preemption authorization based on detecting the triggering condition, wherein the triggering condition includes one or more of a change in a preemption policy applied by the access point in determining whether to authorize preemption, detecting that the end device is applying the at least one type of preemption authorization to a non-authorized traffic flow, an unauthorized traffic type or that the end device is applying the at least one type of preemption authorization despite not being an authorized end device for applying the preemption authorization, and detecting that end device is not applying the at least one type of preemption authorization.

In another aspect, the method further includes advertising a preemption policy for use of preemption in a Basic Service Set (BSS) of the access point by associated end devices, wherein the preemption policy indicates one or more of following: whether preemption is allowed to be used in the BSS, one or more traffic identifiers for which preemption is allowed to be used, one or more Access Categories (ACs) for which preemption is allowed to be used, frequency of preemption that is allowed, preemption is allowed to be used only for traffic flows for which low latency requirement is less than or equal to a specified latency threshold, preemption is allowed to be used by an end device only after a successful negotiation for preemption use with the access point, and a negotiation with the access point is required for use of preemption for flows that fall outside advertised preemption policy of the access point.

In one aspect, an access point includes one or more memories having computer-readable instructions stored therein, and one or more processors. The one or more processors are configured to execute the computer-readable instructions to receive a message indicating parameters associated with network traffic to be exchanged between the access point and an end device; determine at least one type of preemption authorization for the network traffic based on the parameters, the at least one type of preemption authorization being one or more of a flow-based preemption authorization, traffic type-based preemption authorization, and an end device-based preemption authorization; and signal the at least one type of preemption authorization to the end device.

In one aspect, one or more non-transitory computer-readable media includes computer-readable instructions, which when executed by one or more processors of an access point cause the access point to receive a message indicating parameters associated with network traffic to be exchanged between the access point and an end device; determine at least one type of preemption authorization for the network traffic based on the parameters, the at least one type of preemption authorization being one or more of a flow-based preemption authorization, traffic type-based preemption authorization, and an end device-based preemption authorization; and signal the at least one type of preemption authorization to the end device.

### EXAMPLE EMBODIMENTS

IEEE 802.11, commonly referred to as Wi-Fi, has been around for three decades and has become arguably one of the most popular wireless communication standards, with billions of devices supporting more than half of the worldwide wireless traffic. The increasing user demands in terms of throughput, capacity, latency, spectrum, and power efficiency call for updates or amendments to the standard to keep up with them. As such, Wi-Fi generally has a new amendment after every few years with its own characteristic features. In the earlier generations, the focus was primarily higher data rates, but with ever increasing density of devices, area efficiency has become a major concern for Wi-Fi networks. Due to this issue, the last (802.11 be (Wi-Fi 7)) amendments focused more on efficiency though higher data rates were also included. The next expected update to IEEE 802.11 is coined as Wi-Fi 8. Wi-Fi 8 will attempt to further improve reliability and minimize latency to meet the ever-growing demand for the Internet of Things (IoT), high resolution video streaming, low-latency wireless services, wireless Time Sensitive Networking (TSN) etc.

Multiple Access Point (AP) coordination and transmission in Wi-Fi refers to the management of multiple access points in a wireless network to avoid interference and ensure efficient communication between the STA devices and the network. When multiple access points are deployed in a network – for instance in buildings and office complexes – they operate on the same radio frequency, which can cause interference and degrade the network performance. To mitigate this issue, access points can be configured to coordinate their transmissions and avoid overlapping channels.

Ultra-High Reliability (UHR) in Wi-Fi 8 refers to a set of features and operational modes to deliver highly reliable and deterministic communication for Low Latency (LL) traffic and/or loss-sensitive applications (high QoS requirement). UHR is considering preemption for supporting low latency, to achieve target latencies (e.g., latency < TXOP duration of 1-5 msec). Preemption is being considered to achieve low latency (LL) for both event-based/aperiodic traffic as well as more predicable periodic traffic.

802.11be defines Stream Classification Service (SCS) with QoS Characteristics element that can be used to provide QoS/LL requirements for such traffic. However, some low latency event-based traffic may not be critical in some deployments and thus may not need preemption. For example, an industrial alarm which triggers an automated control can be considered to require preemption while an alarm which is for displaying an event to the operator may not need preemption since time scale is in hundreds of msec to a second. Hence, there is a need for the AP to provide preemption authorization for traffic flows (periodic and/or event-based) on a more granular scale (e.g., for specific flows, specific types of traffic, and/or for specific end devices (STA(s)).

Aspects of the present disclosure are directed to various mechanisms and signaling procedure that can be utilized in WiFi systems to provide such granular and more targeted preemption authorization.

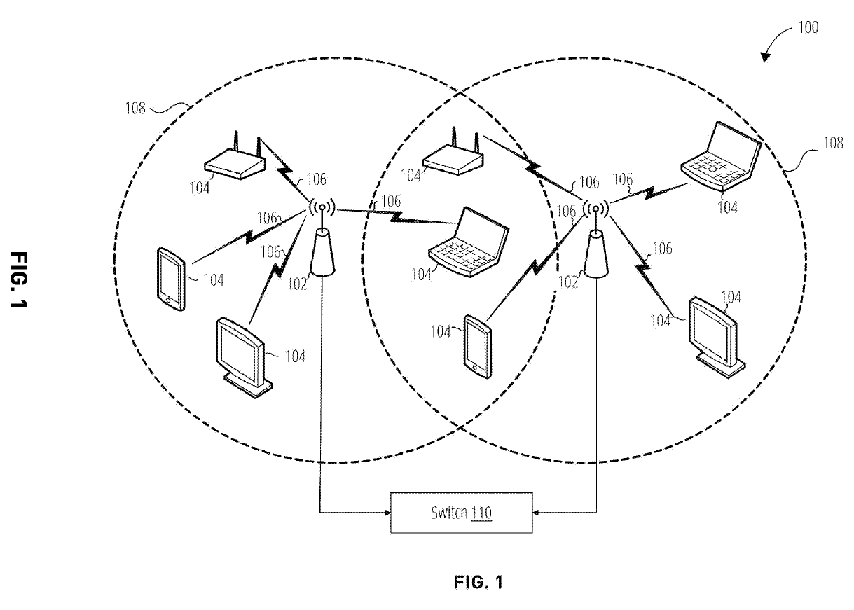

FIG. 1 illustrates a block diagram of an example wireless communication network according to some aspects of the present disclosure.

According to some aspects, the wireless communication network 100 may be an example of a wireless local area network (WLAN) such as a Wi-Fi network. For example, the wireless communication network 100 may be a network implementing at least one of the IEEE 802.11 family of wireless communication protocol standards and amendments thereof (such as that defined by the IEEE 802.11-2016 specification or amendments thereof including, but not limited to, 802.11ay, 802.11ax, 802.11az, 802.11ba and 802.11be). Additionally, the wireless communication network 100 may implement future versions and amendments of the wireless communication protocol standards and amendments thereof such as 802.11bn and be modified according to the present disclosure to include the features contained herein.

Wireless communication network 100 may include numerous wireless communication devices such as an AP, which can be one or more of a non-MLD AP, an AP affiliated with an AP MLD, and/or an AP MLD. In the examples presented herein, the AP can exclude an upper UMAC. Therefore, the AP can include the lower UMAC, LMAC, and/or PHY. Additionally, the WLAN can include one or more of STAs 104, which can be one or more of a non-MLD STA, a STA affiliated with a non-AP MLD, and/or a non-AP MLD. As illustrated, wireless communication network 100 also may include multiple APs such as APs 102 (may also be referred to as simply AP). APs 102 can be coupled to one another through a switch 110. While APs 102 are shown as being coupled to one another through switch 110, wireless communication network 100 can provide another device that allows the coupling of multiple APs. In another example, switch 110 can be a network controller configured to coordinate and manage operations of different APs such as APs 102.

Each of STAs 104 also may be referred to as a mobile station (MS), a mobile device, a mobile handset, a wireless handset, an access terminal (AT), a user equipment (UE), a subscriber station (SS), client, or a subscriber unit, among other examples. The STAs 104 may represent various devices such as mobile phones, personal digital assistant (PDAs), other handheld devices, netbooks, notebook computers, tablet computers, laptops, display devices (for example, TVs, computer monitors, navigation systems, among others), music or other audio or stereo devices, remote control devices (“remotes”), printers, kitchen or other household appliances, key fobs (for example, for passive keyless entry and start (PKES) systems), among other examples. In other examples, the STAs 104 can be referred to as clients and/or client devices.

Any one of APs 102 and an associated set of STAs (e.g., STAs 104) may be referred to as a basic service set (BSS), which is managed by a respective AP of APs 102. FIG. 1 additionally shows an example coverage area 108 of the each of APs 102, which may represent a basic service area (BSA) of wireless communication network 100. As illustrated, three of STAs 104 are within the BSA of each of APs 102. The BSS may be identified to users by a service set identifier (SSID), where the BSS might be one of many in the SSID. The BSS may be identified to other devices by a unique (or substantially unique) basic service set identifier (BSSID). One or more of APs 102 periodically broadcasts beacon frames (“beacons”) including the BSSID to enable STAs 104 within a wireless range of one or more of APs 102 to “associate” or re-associate with APs 102 to establish a respective communication link of communication links 106 (hereinafter also referred to as a “Wi-Fi link”), or to maintain communication links 106, with APs 102. For example, the beacons may include an identification of a primary channel used by respective AP of APs 102 as well as a timing synchronization function for establishing or maintaining timing synchronization with APs 102. APs 102 may provide communication links 106 to STAs 104 and therefore access to external networks. While the example has been described in regard to APs 102 and STAs 104, the present disclosure extends such that an AP may provide access to external networks to various STAs in a WLAN via communication links 106.

To establish communication links 106 with any one of APs 102, each of STAs 104 is configured to perform passive or active scanning operations (“scans”) on frequency channels in one or more frequency bands (for example, the 2.4 GHz, 5 GHz, 6 GHz, or 60 GHz bands). To perform passive scanning, STAs 104 listen for beacons, which are transmitted by a respective AP of APs 102 at or near a periodic time referred to as the target beacon transmission time (TBTT) (measured in time units (TUs) where one TU may be equal to 1024 microseconds (µs)). To perform active scanning, STAs 104 generate and sequentially transmits probe requests on each channel to be scanned and listens for probe responses from APs 102. STAs 104 may be configured to identify or select an AP and thence a selected AP of APs 102 with which to associate based on the scanning information obtained through the passive or active scans, and to perform authentication and association operations to establish the communication links 106 with the selected AP of APs 102. The selected AP of APs 102 assigns an association identifier (AID) to STAs 104 at the culmination of the association operations, which selected AP of APs 102 uses to improve the efficiency of certain signaling to the STAs 104.

The present disclosure modified the WLAN radio and baseband protocols for the PHY and medium access controller (MAC) layers. APs 102 and STAs 104 transmit and receive wireless communications (hereinafter also referred to as “Wi-Fi communications”) to and from one another in the form of PHY protocol data units (PPDUs). APs 102 and STAs 104 also may be configured to communicate over other frequency bands such as shared licensed frequency bands, where multiple operators may have a license to operate in the same or overlapping frequency band or bands.

Each PPDU is a composite structure that includes a PHY preamble and a payload in the form of one or more PHY service data unit (PSDU). The information provided in the preamble may be used by a receiving device to decode the subsequent data in an intended PSDU. In instances in which PPDUs are transmitted over a bonded channel, selected preamble fields may be duplicated and transmitted in each of the multiple component channels.

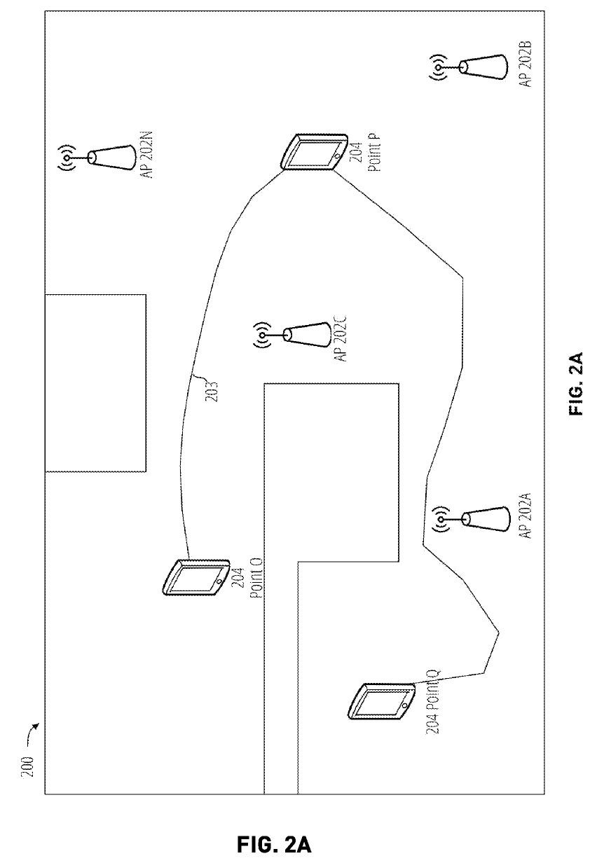

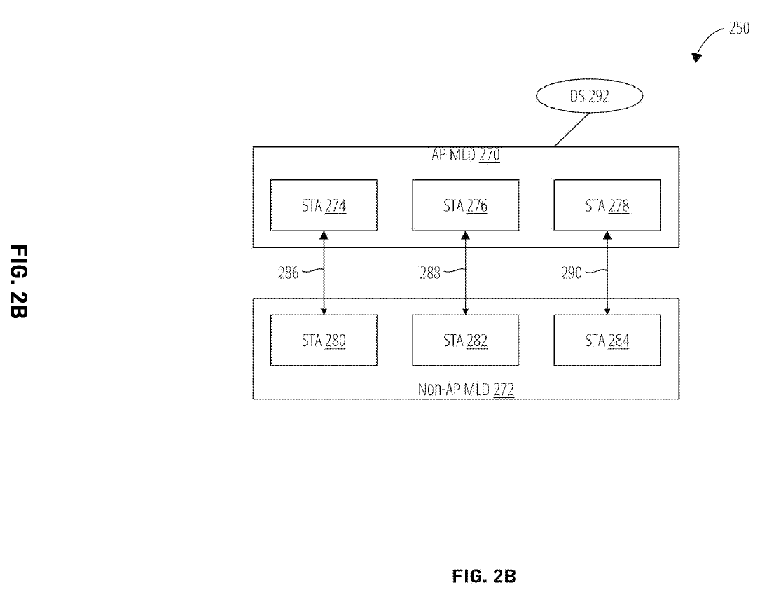

FIG. 2A illustrates an example of a single floor of building equipped with wireless communication according to some aspects of the present disclosure.

While only a single floor 200 is illustrated a description equally applies to multiple floors in a building. Additionally, some of the floors in a building may not be contiguous, such that floors 1, 3, 4, and 8 span a network for a building that has floors 1-10. Thus, in at least one implementation the building can include one or more floors that do not have a network including one or more APs. As illustrated, the single floor 200 includes AP 202A, AP 202B, AP 202C, and AP 202N. Each of the AP 202A, AP 202B, AP 202C, and/or AP 202N can have a respective coverage area such that an overall coverage area can span substantially the entire floor. In other examples, the overall coverage area can extend beyond the entire floor. In other examples, the overall coverage area can extend beyond the entire floor. Additionally, the coverage of an AP of AP 202A, AP 202B, AP 202C, and AP 202N may substantially overlap with the coverage of another AP of the AP 202A, AP 202B, AP 202C, and AP 202N.

As illustrated by line 203, STA 204 can move from point O to point P to point Q. When a STA 204 is moving around on a given floor, one or more of AP 202A, AP 202B, AP 202C, and AP 202N can be considered to be nearest to STA 204. Nearest as used in relation to AP 202A, AP 202B, AP 202C, AP 202N and STA 204 can include being physically nearest (for example, a Euclidean distance on the floor) and/or pathloss-nearest (for example, having the lowest wireless attenuation (pathloss) between a subset of APs, among all the APs, and the STA). Additionally, the pathloss-nearest approach can be used to reduce the likelihood of connection between an AP on a floor above or below STA 204. The location of the AP on the floor above or below might be closer in a Euclidean sense, but also not be a desirable AP for the connection of the device or station due to the floor location and/or possible signal interruption. The location of the AP on the floor above or below might be closer in a straight line and/or Euclidean sense, but also not be a desirable AP for the connection of the device or station due to the floor location and/or possible signal interruption. Additionally, the coverage of one or more APs can at least partially overlap with the coverage of one or more other APs. The present disclosure provides for selecting the AP and/or providing a communication pathway from one or more STA through one or more APs.

FIG. 2B depicts an illustrative schematic diagram for MLO between an AP MLD with affiliated logical entities and a non-AP MLD with affiliated logical entities according to some aspects of the present disclosure.

Referring to FIG. 2B, schematic diagram 250 may include two multi-link logical entities AP MLD 270 and non-AP MLD 272. AP MLD 270 may include physical and/or logically affiliated AP such as AP 274, AP 276, and AP 278 operating in different channels and typically different frequency bands (e.g., 2.4 GHz, 5 GHz, and 6 GHz). AP 274, AP 276, and AP 278 may be the same as or similar to any one of the APs described above. In one example, non-AP MLD 272 may include STA 280, STA 282, and STA 284, which may be the same as or similar to any of the STAs as described herein.

AP 274 may communicate with STA 280 via link 286. AP 276 may communicate with STA 282 via link 288. AP 278 may communicate with STA 284 via link 290.

AP MLD 270 is shown in FIG. 2B to have access to a distribution system (DS) such as DS 292, which is a system used to interconnect a set of BSSs to create an extended service set (ESS).

It should be understood that although the example shows three logical entities within the AP MLD and the three logical entities within the non-AP MLD, this is merely for illustration purposes and that other numbers of logical entities within each of the AP MLD and Non-AP MLD may be envisioned. The example Wi-Fi systems and MLO described above with reference to FIGS. 1 and 2A-2B provide examples of simplified and example systems of the present disclosure.

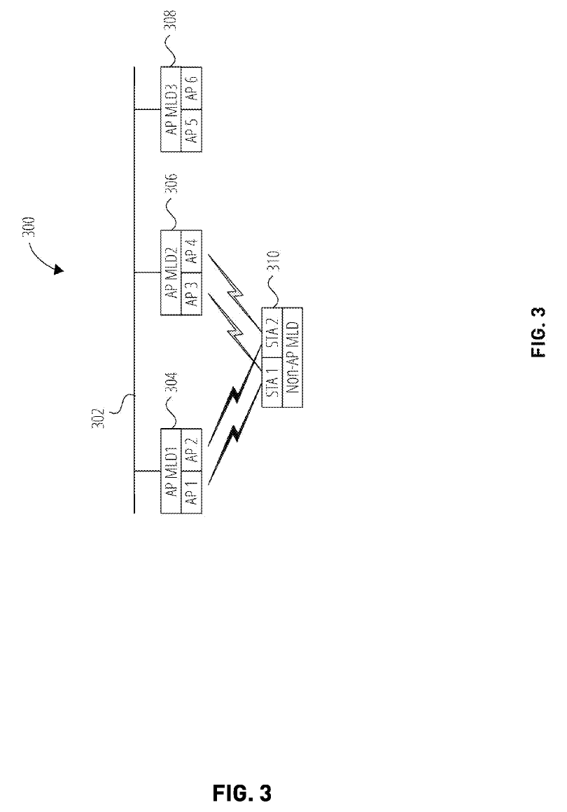

FIG. 3 illustrates an example architecture 300 in which multi-AP coordination technologies may be practiced according to some aspect of the present disclosure.

The architecture 300 includes a DS 302 (may be the same as the DS 292) that is a logically connected entity that includes AP MLD1 304, AP MLD2 306, and AP MLD3 308, all of which can form an ESS (e.g., all AP MLDs which are part of a campus ESS network). Architecture 300 also shows a non-AP MLD 310 that may be connected to AP MLD1 304.

AP MLD1 304 may include one or more APs such as AP1 and AP2. AP1 and AP2 may be different physical APs (or AP interfaces) co-located in AP MLD1 304. Similarly, AP MLD2 306 may include one or more APs such as AP3 and AP4. AP3 and AP4 may be different physical APs (or AP interfaces) co-located in AP MLD2 306. Similarly, AP MLD3 308 may include one or more APs such as AP5 and AP6. AP5 and AP6 may be different physical APs (or AP interfaces) co-located in AP MLD3 308. The number of AP MLDs and/or the number of respective APsof each AP MLD is not limited to the example numbers shown in FIG. 2B and may include more or less.

In one example, AP MLD1 304, AP MLD2 306, and AP MLD3 308 may be located in different geographical locations (e.g., different rooms of the same building, different floors of the same building, different buildings of the same campus or area, etc.).

The non-AP MLD 310 may be any known or to be developed device capable of establishing one or more wireless communication links with one or more of AP MLD1 304, AP MLD2 306, and/or AP MLD3 308. As a non-limiting example, non-AP MLD 310 may be a mobile device having two wireless interfaces, each of which may correspond to one of STA 1 or STA 2. In one example, each one of STA 1 and STA 2 may operate on a different link (e.g., 5 GHz for STA 1 and 6 GHz for STA 2). The number of non-AP MLDs and/or STAs associated with each is not limited to that shown in FIG. 3 and may be more or less.

As shown in FIG. 3, the non-AP MLD 310 is associated with the architecture 300 with multiple links set up with the AP MLD1 304 (for example, 2.4 GHz link with the AP1 for the STA 1 and 5 GHz link with the AP2 for the STA 2). For one of the links (for example, 2.4 GHz), the AP MLD1 304 may detect a weak RSSI. As a result, AP MLD1 304 determines a specific roaming target AP3 of AP MLD2 306 for that link to Switch too. Similarly, the same process may be performed for the other link (for example, the 5 GHz) to Switch to a link with STA 4 on the AP MLD2 205.

802.11be defies preemption as a mechanism by which a device—typically an Access Point (AP)—can preempt or interrupt an ongoing or scheduled transmission by another device in order to gain access to the medium for high-priority traffic (e.g., a LL periodic and/or event-based traffic flow). One example application of preemption is in the MLO context, where a device operates simultaneously across multiple frequency links. Preemption can support QoS by allowing time-sensitive or high-priority traffic (e.g., voice or VR) to override lower-priority ongoing communications. Preemption can ensure that a link is freed up quickly to send urgent data, rather than waiting for existing traffic to complete.

As noted above, 802.11be defines Stream Classification Service (SCS) with QoS Characteristics element that can be used to provide QoS/LL requirements for such traffic. However, some low latency event-based traffic may not be critical in some deployments and thus may not need preemption. For example, an industrial alarm which triggers an automated control can be considered to require preemption while an alarm which is for displaying an event to the operator may not need preemption since time scale is in hundreds of msec to a second. Hence, there is a need for the AP to provide preemption authorization for traffic flows (periodic and/or event-based) on a more granular scale (e.g., for specific flows, specific types of traffic, and/or for specific end devices (STA(s)).

Aspects of the present disclosure are directed to various mechanisms and signaling procedure that can be utilized in WiFi systems to provide such granular and more targeted preemption authorization.

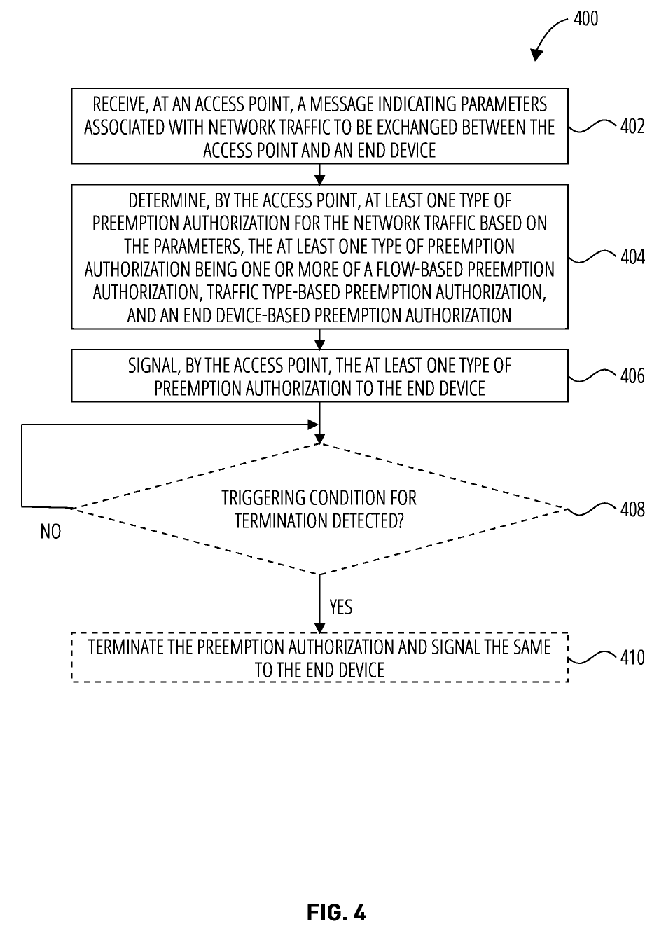

FIG. 4 illustrates an example method of granular preemption authorization use, according to some aspects of the present disclosure.

Steps of FIG. 4 may be performed by any given access point (e.g., any one of APs 102, one or more of APs described with reference to FIGS. 2A and 2b, AP MLD 304, AP MLD 306, AP MLD 308, etc.) and/or alternatively by a centralized controller (e.g., switch 110 functioning as an overlay control components for managing operations of APs 102).

In example process 400, at step 402, an access point may receive a message from an end device (e.g., an STA such as anyone of STAs 104, non-AP MLD 272, non-AP MLD 310, etc.). In one example, the message may include one or more parameters associated network traffic that is to be transmitted (exchanged) between the end device and the access point. The network traffic may be currently buffered network traffic or anticipated/expected traffic in the near future.

In one example, the parameters included in the message that are associated with the network traffic include, but are not limited to, QoS requirements and/or preemption requirements for the network traffic.

In one example, the message may be a SCS frame, where the parameters are included in an existing QoS element of the SCS frame. In another example, an extended QoS element may be defined and used in the SCS frame to include the parameters for the network traffic.

In another example, the message may be a (Re)Association Request as defined in the standards. For example, the parameters can be included in the SCS Descriptor element, an optional Preemption element (that may be defined and included in the (Re)Association Request), or any other known or to be added subelement in the (Re)Association Request.

In one example, the access point may receive such message from more than one end device and each message may include the same or different parameters (e.g., network traffic with different QoS, preemption requirement, etc.)

At step 404, the access point may determine at least one type of preemption authorization for the network traffic based on the parameters included in the message and/or a preemption policy of the access point.

For example, the access point's preemption policy may be to allow preemption for specific flows for a given deployment (e.g., allow preemption for traffic flows associated with Industrial Internet of Things (IIoT). In one example, a flow specific preemption authorization may be referred to as a flow-based preemption authorization. In this example, the access point may determine that the parameters for the network traffic indicate that the network traffic is a periodic LL traffic and/or has a threshold priority requiring high QoS. Therefore, the access point may determine that given the high QoS indicated by the parameters and the access point's policy to grant preemption to such high QoS network traffic, the preemption for such flow(s) should be authorized.

In another example, the access point may take into consideration the parameters for network traffic received from multiple end devices and based on the different parameters determine which flows to authorized preemption for and which flows not to authorize preemption for, based on a given policy.

In one example, the access point's preemption policy may be to allow preemption for specific types of network traffic. For instance, the access point may allow preemption for one or more TIDs (e.g., TIDs ≥ 4, TIDs ≥ 6, etc.). In another example, the access point may allow preemption for one or more ACs (e.g., AC_VO, AC_VI, etc.). In another example, the access point may allow preemption for a combination of one or more ACs and TIDs that may correspond to the allowed ACs (e.g., allow preemption for AC_VO and TIDs 4 and 6). This type of preemption authorization may be referred to as traffic type-based preemption authorization.

In another example, the access point's preemption policy may be to allow preemption to only a specific STA or a set of STAs. As an example, in an IIoT deployment, Automated Guided Vehicles (AGVs) and Automated Mobile Robots (AMRs) are allowed to use preemption. This type of preemption authorization may be referred to as end device-based preemption authorization (device-based preemption authorization).

In another example, the access point may determine the type of preemption authorization to be any one or more of flow-based preemption authorization, traffic type-based preemption authorization, and end device-based preemption authorization. For example, the access point may authorize preemption for certain flows or TIDs/ACs originating from a specific set or type of STAs.

In one example, in addition to determine the type of preemption authorization, the access point may determine a frequency for applying the authorized preemption (e.g., once per TXOP every one hundred msec or every second for authorized flow(s), authorized TID(s) and/or AC(s), and/or authorized device(s), etc.), and/or one or more time periods during which the traffic type-based preemption authorization is valid (e.g., time periods in which preemption for authorized flow(s), authorized TID(s) and/or AC(s), and/or authorized device(s) is permitted, etc.).

At step 406, the access point may signal (send or transmit) the at least one type of preemption authorization determined at step 404 to the end device and/or to a group of STAs connected to the access point. In another example, the access point may signal the at least one type of preemption authorization to other nearby (neighboring) access points.

In one example, when the message received at step 402 is a SCS frame (SCS Request) with QoS Characteristics, the access point may signal the at least one type of preemption authorization in a SCS Response. In another example, the signaling at step 406 may via an unsolicited SCS Response (e.g., when preemption authorization is provided at a later stage such as after authentication with an Authentication Server).

In another example, when the message is a (Re)Association Request, the access point may signal the at least one type of preemption authorization in a (Re)Association Response. Thus, the message exchange at step 402 and step 406 may constitute a (Re)Association Request/Response exchange.

In another example, a different action frame (e.g., other than SCS frame or (Re)Association Request/Response) may be utilized for receiving the message at step 402 and signaling the at least one type of preemption authorization at step 406. For example, a Preemption Request/Response may be used at step 402 and step 404 or a new frame can be defined whereby, the end device(s) can send a Preemption Request to request for preemption for one or more SCS flow(s), one or more TID(s), one or more device(s), etc.) In response, the access point can accept or reject (partially or completely) the preemption request received from the end device(s) based on preemption policy, traffic parameters, and/or other known SCS flows, and signal the type of the preemption authorization in a Preemption Response frame.

Once the end device(s) has/have authorization for using preemption from the access point, and when the preemption is enabled by the access point in the corresponding BSS, then the end device(s) can use the preemption for delivery of LL traffic for the authorized network traffic (e.g., authorized SCS flow, flows carried over authorized TID(s) and/or AC(s), in general for delivery of LL traffic flows if the preemption authorization is an end device-based preemption authorization (e.g. for AGVs or AMRs in IIoT), etc.).

Example process 400 may further include one or more optional steps, including step 408 and step 410 (shown using dashed lines in FIG. 4). Step 408 and step 410 may be performed to terminate an authorized preemption.

At step 408, the access point may determine whether a triggering condition for terminating the at least one type of preemption authorization signaled at step 406 is detected or not. If not (No at step 408), the access point may continuously or periodically or randomly repeat the process at step 408 until such triggering condition is detected (Yes at step 408).

In one example, the triggering condition can be a change in a preemption policy applied by the access point in determining whether to authorize preemption. Such preemption policy may change according to any known or to be developed conditions (e.g., change in congestion experienced in the Downlink (DL) or Uplink (UL) transmissions based on Buffer Status Report (BSR).

In another example, the triggering condition can be a detection of the end device(s) not honoring the preemption authorization signaled at step 406. For example, when the end device(s) applies the at least one type of preemption authorization to a non-authorized traffic flow (e.g., a different SCS flow than the one authorized in the signaled preemption authorization), an unauthorized traffic type (e.g., to a different TID than the one authorized), or that the end device is applying the at least one type of preemption authorization despite not being an authorized end device for applying the preemption authorization, the access point may conclude that the device(s) is/are not honoring the preemption authorization.

In another example, the triggering condition can be a detection of end device not applying the at least one type of preemption authorization at all (e.g., for a configurable threshold amount of time).

Once any one or more of the triggering conditions is/are detected at step 408, at step 410, the access point may terminate the at least one type of preemption authorization and signal the same to the end device(s). In one example, such termination may be signaled via an unsolicited Preemption Response frame with a 'termination' indication for the at preemption authorization signaled at step 406.

In another example, if upon signaling the termination at step 410, the access point determines that the end device(s) is/are still not following the preemption authorization and/or still apply the preemption authorization to unauthorized flows, traffic types, and devices, the access point may disassociate the end device(s) from the access point using any known or to be developed disassociation techniques defined in the standards.

In another aspect, example process 400 may further include a step of advertising a preemption policy. For example, the access point may advertise a preemption policy for use of preemption in a Basic Service Set (BSS) of the access point by associated end devices, wherein the preemption policy indicates one or more of following: whether preemption is allowed to be used in the BSS, one or more traffic identifiers for which preemption is allowed to be used, one or more Access Categories (ACs) for which preemption is allowed to be used, frequency of preemption that is allowed, preemption is allowed to be used only for traffic flows for which low latency requirement is less than or equal to a specified latency threshold (e.g. preemption can be only used for traffic flows with low latency requirement of <= 10 msec), preemption is allowed to be used by an end device only after a successful negotiation for preemption use with the access point, and a negotiation with the access point is required for use of preemption for flows that fall outside advertised preemption policy of the access point. In another example, the access point may advertise some preemption policy (e.g., based on TIDs or ACs or latency threshold as described above) for use of preemption in the BSS and require negotiation for use of preemption for other flows that fall outside the advertised policy. In one case the preemption policy is advertised or provided in beacon, probe response, (re)association response or another management frame.

In some examples, after preemption (PR) is authorized for a LL event-based flow often LL traffic needing PR may be active only intermittently. For example, in manufacturing a robotic arm, operation may need preemption for a short period of time (e.g., 100 msec to 1 sec) when performing critical/precise operation, other times it can tolerate higher latency. Therefore, even if flows are authorized for PR it does not result in enabling PR always. In other words, preemption authorization may be followed by preemption enablement, which will be described below.

For enablement, an end device (e.g., an STA such as anyone of STAs 104, non-AP MLD 272, non-AP MLD 310, etc.) may signal PR-Start and PR-End in A-Control. For example, STA signals start of period when LL event-based flows needing PR are active, based on STA’s estimate, and indicates end of period when PR is no longer needed. In another example, STA indicates preemption Start (PR-Start) and PR-End in a UHR A-Control field, e.g. at a fine time granularity per its knowledge of LL flows. These mechanisms avoid management frame overhead and added delays when LL flows needing PR become active/inactive.

In another example, for preemption enablement, the access point can enable preemption in the BSS considering preemption authorized flows, PR Start/End indication received from STAs, and/or access point’s policy and determination of when LL flows needing PR could be active. This determination can be made using Artificial Intelligence and trained machine learning models. Such trained machine learning models can be developed to receive a variety of inputs on past network performance parameters and preemption authorizations and determine which LL flows should be active. The trained machine learning model can be any known or to be developed model, neural network, etc.

For preemption enablement, access point’s policy for preemption can be advertised in Beacon (e.g. in UHR Operation element). This can have a short PPDU length (e.g., 1 msec), maximum number of PRs in a TXOP (e.g., may limit to 1). In one example, access point and STA can indicate support for preemption in UHR Capabilities element.

In another example, the access point can signal that preemption is enabled/allowed in the BSS. This indication can be provided through PPDU level signaling (e.g., UHR A-Control field, or in UHR preamble). This signaling can provide an indication of whether PR is enabled for DL, UL, or both. Such signaling can be provided in Beacon and/or Probe Response (e.g., when PR is enabled for longer than TBTT).

When the access point signals PR is enabled in UL, supporting STAs also signal PR is enabled in their respective UL through PPDU (e.g., via UHR A-Control field or in UHR preamble). When PR is enabled in DL, the access point may split the long PPDUs into shorter PPDUs. When PR is enabled in UL, preemption supporting STAs split long PPDUs into short PPDUs. In some examples, preemption can be triggered by the STA or the access point for authorized LL flows only when PR is enabled/allowed in the corresponding direction.

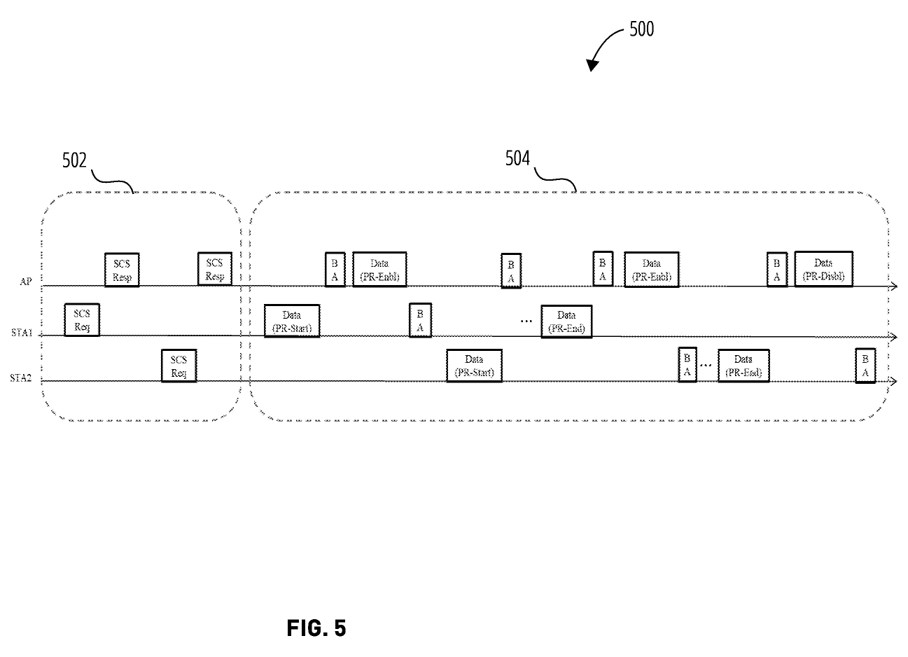

FIG. 5 is a visualization of a preemption authorization and enablement lifecycle, according to some aspects of the present disclosure. Non-limiting example diagram 500 shows such lifecycle between one access point and two example end devices (STAs). Phase 502 illustrates the PR authorization process as described above with reference to FIG. 4. This phase may include SCS Request to register LL event-based flow. AP indicates preemption authorization in SCS Response). Timeline and sequence of signals exchanged for PR authorization is shown in this phase 502.

Phase 504 illustrates the enablement/disabling of preemption as described above. This phase may include Dynamic PR-Start and PR-End signaling from STAs to indicate periods when preemption is needed, and in-band PR enabled signaling from AP to indicate when preemption is enabled/allowed (access point can also consider deployment specific network policy/prediction to determine when to enable/disable PR, and when preemption is no longer needed, AP can signal that PR is disabled). Timeline and sequence of signals exchanged for PR enabling and disabling including Block Acknowledgements (BAs) are shown in this phase 504.

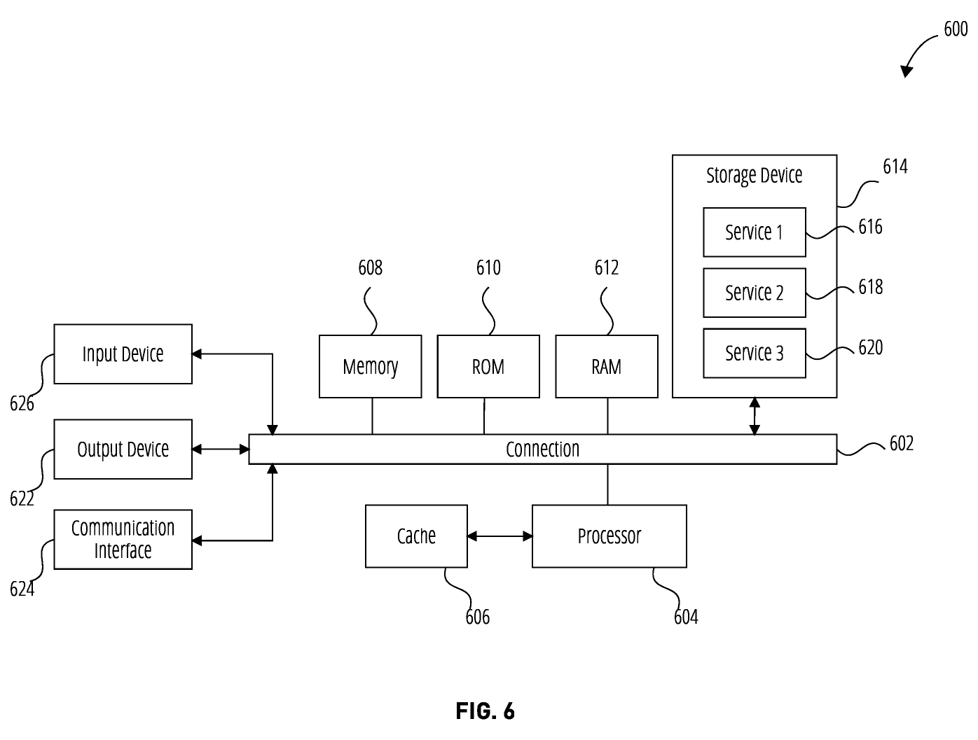

FIG. 6 shows an example of computing system according to some aspects of the present disclosure.

For example, computing system 600 may be any component of wireless communication network 100 and settings shown in FIGS. 1-3 such as APs 102, switch 110 (controller), STAs 104, APs and devices shown in FIGS. 2A and 2B, AP MLD 1 304, AP MLD 2 306, AP MLD 3 308, non-AP MLD 310, and/or any component of thereof. Various components of computing system 600 may be in communication with each other using connection 602. Connection 602 can be a physical connection via a bus, or a direct connection into processor 604, such as in a chipset architecture. Connection 602 can also be a virtual connection, networked connection, or logical connection.

In some examples, computing system 600 is a distributed system in which the functions described in this disclosure can be distributed within a datacenter, multiple data centers, a peer network, etc. In some embodiments, one or more of the described system components represents many such components each performing some or all of the function for which the component is described. In some embodiments, the components can be physical or virtual devices.

Example computing system 600 includes at least one processing unit (CPU or processor) such as processor 604 and connection 602 that couples various system components including system memory 608, such as read-only memory (ROM) such as ROM 610 and random access memory (RAM) such as RAM 612 to processor 604. Computing system 600 can include a cache of high-speed memory 606 connected directly with, in close proximity to, or integrated as part of processor 604.

Processor 604 can include any general purpose processor and a hardware service or software service, such as services 616, 618, and 620 stored in storage device 614, configured to control processor 604 as well as a special-purpose processor where software instructions are incorporated into the actual processor design. Processor 604 may essentially be a completely self-contained computing system, containing multiple cores or processors, a bus, memory controller, cache, etc. A multi-core processor may be symmetric or asymmetric.

To enable user interaction, computing system 600 includes an input device 626, which can represent any number of input mechanisms, such as a microphone for speech, a touch-sensitive screen for gesture or graphical input, keyboard, mouse, motion input, speech, etc. Computing system 600 can also include output device 622, which can be one or more of a number of output mechanisms known to those of skill in the art. In some instances, multimodal systems can enable a user to provide multiple types of input/output to communicate with computing system 600. Computing system 600 can include communication interface 624, which can generally govern and manage the user input and system output. There is no restriction on operating on any particular hardware arrangement, and therefore the basic features here may easily be substituted for improved hardware or firmware arrangements as they are developed.

Storage device 614 can be a non-volatile memory device and can be a hard disk or other types of computer readable media which can store data that are accessible by a computer, such as magnetic cassettes, flash memory cards, solid state memory devices, digital versatile disks, cartridges, random access memories (RAMs), read-only memory (ROM), and/or some combination of these devices.

The storage device 614 can include software services, servers, services, etc., that when the code that defines such software is executed by the processor 604, it causes the system to perform a function. In some embodiments, a hardware service that performs a particular function can include the software component stored in a computer-readable medium in connection with the necessary hardware components, such as processor 604, connection 602, output device 622, etc., to carry out the function.

For clarity of explanation, in some instances, the present technology may be presented as including individual functional blocks including functional blocks comprising devices, device components, steps or routines in a method embodied in software, or combinations of hardware and software.

Any of the steps, operations, functions, or processes described herein may be performed or implemented by a combination of hardware and software services or services, alone or in combination with other devices. In some examples, a service can be software that resides in memory of a client device and/or one or more servers of a content management system and perform one or more functions when a processor executes the software associated with the service. In some examples, a service is a program or a collection of programs that carry out a specific function. In some embodiments, a service can be considered a server. The memory can be a non-transitory computer-readable medium.

In some examples, the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer-readable media. Such instructions can comprise, For example, instructions and data which cause or otherwise configure a general purpose computer, special purpose computer, or special purpose processing device to perform a certain function or group of functions. Portions of computer resources used can be accessible over a network. The executable computer instructions may be, For example, binaries, intermediate format instructions such as assembly language, firmware, or source code. Examples of computer-readable media that may be used to store instructions, information used, and/or information created during methods according to described examples include magnetic or optical disks, solid-state memory devices, flash memory, USB devices provided with non-volatile memory, networked storage devices, and so on.

Devices implementing methods according to these disclosures can comprise hardware, firmware and/or software, and can take any of a variety of form factors. Typical examples of such form factors include servers, laptops, smartphones, small form factor personal computers, personal digital assistants, and so on. The functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

What is claimed is:

1. A method comprising:
establishing, by an access point (AP) multi-link device (MLD), an association with a non-AP MLD;
receiving, by the AP MLD, a Stream Classification Service (SCS) request frame from the non-AP MLD, wherein the SCS request frame comprising a Quality of Service (QoS) characteristics element including data indicating a flow and a request for preemption authorization for the flow;
determining, by the AP MLD, whether to allow the preemption authorization for the flow indicated in the SCS request frame; and
transmitting, by the AP MLD, a SCS response frame to the non-AP MLD including data indicating allowance of the preemption authorization for the flow indicated in the SCS request frame.

2. The method of claim 1 further comprising:
subsequent to transmitting the SCS response frame indicating acceptance of the preemption authorization:
receiving, by the AP MLD, a message from the non-AP MLD to initiate enablement of preemption for the flow; and
enabling, by the AP MLD, preemption for the flow.

3. The method of claim 2 further comprising:
while the preemption for the flow is enabled, providing, by the AP MLD, access to a wireless medium during a TXOP in response to a preemption indication from the non-AP MLD.

4. The method of claim 1 further comprising:
advertising, by the AP MLD, support for preemption for low latency data flows.

5. The method of claim 4 wherein the advertising comprises transmitting one or more beacon frames including an indication of support for the preemption of low latency data flows.

6. The method of claim 1 wherein the QoS characteristics element further comprises one or more QoS parameters for the flow.

7. The method of claim 1 wherein the determining whether to allow the preemption authorization for the flow is based on a preemption policy.

8. An access point (AP) multi-link device (MLD) comprising:
one or more memories; and
one or more processors communicatively coupled to the one or more memories, wherein the one or more processors are configured to, individually or collectively, perform operations comprising:
establishing, by the AP MLD, an association with a non-AP MLD;
receiving, by the AP MLD, a Stream Classification Service (SCS) request frame from the non-AP MLD, wherein the SCS request frame comprising a Quality of Service (QoS) characteristics element including data indicating a flow and a request for preemption authorization for the flow;
determining, by the AP MLD, whether to allow the preemption authorization for the flow indicated in the SCS request frame; and
transmitting, by the AP MLD, a SCS response frame to the non-AP MLD including data indicating allowance of the preemption authorization for the flow indicated in the SCS request frame.

9. The AP MLD of claim 8, the operations further comprising:
subsequent to transmitting the SCS response frame indicating acceptance of the preemption authorization:
receiving, by the AP MLD, a message from the non-AP MLD to initiate enablement of preemption for the flow; and
enabling, by the AP MLD, preemption for the flow.

10. The AP MLD of claim 9, the operations further comprising:
while the preemption for the flow is enabled, providing, by the AP MLD, access to a wireless medium during a TXOP in response to a preemption indication from the non-AP MLD.

11. The AP MLD of claim 8, the operations further comprising:
advertising, by the AP MLD, support for preemption for low latency data flows.

12. The AP MLD of claim 11 wherein the advertising comprises transmitting one or more beacon frames including an indication of support for the preemption of low latency data flows.

13. The AP MLD of claim 8 wherein the QoS characteristics element further comprises one or more QoS parameters for the flow.

14. The AP MLD of claim 8 wherein the determining whether to allow the preemption authorization for the flow is based on a preemption policy.

15. A non-transitory computer readable storage medium comprising instructions that when executed configure one or more processors of an access point (AP) multi-link device (MLD) to perform operations comprising:
establishing, by the AP MLD, an association with a non-AP MLD;
receiving, by the AP MLD, a Stream Classification Service (SCS) request frame from the non-AP MLD, wherein the SCS request frame comprising a Quality of Service (QoS) characteristics element including data indicating a flow and a request for preemption authorization for the flow;
determining, by the AP MLD, whether to allow the preemption authorization for the flow indicated in the SCS request frame; and
transmitting, by the AP MLD, a SCS response frame to the non-AP MLD including data indicating allowance of the preemption authorization for the flow indicated in the SCS request frame.

16. The non-transitory computer readable storage medium of claim 15, the operations further comprising:
subsequent to transmitting the SCS response frame indicating acceptance of the preemption authorization:
receiving, by the AP MLD, a message from the non-AP MLD to initiate enablement of preemption for the flow; and
enabling, by the AP MLD, preemption for the flow.

17. The non-transitory computer readable storage medium of claim 16, the operations further comprising:
while the preemption is enabled for the flow, providing, by the AP MLD, access to a wireless medium during a TXOP in response to a preemption indication from the non-AP MLD.

18. The non-transitory computer readable storage medium of claim 15, the operations further comprising:
advertising, by the AP MLD, support for preemption for low latency data flows.

19. The non-transitory computer readable storage medium of claim 18 wherein the advertising comprises transmitting one or more beacon frames including an indication of support for the preemption of low latency data flows.

20. The non-transitory computer readable storage medium of claim 15 wherein the QoS characteristics element further comprises one or more QoS parameters for the flow.

21. The non-transitory computer readable storage medium of claim 15 wherein the determining whether to allow the preemption authorization for the flow is based on a preemption policy.
